(19) United States
(12) Patent Application Publication
(10) Pub. No.: US 2025/0389335 A1
(43) Pub. Date: Dec. 25, 2025

(54) DIAPHRAGM VALVE, VALVE DIAPHRAGM AND DIAPHRAGM LAYER WITH SEPARATING SECTION

(71) Applicant: GEMÜ Gebr. Müller Apparatebau GmbH & Co. Kommanditgesellschaft, Ingelfingen (DE)

(72) Inventors: Michael Klemt, Pfedelbach (DE); Steffen Meinikheim, Ingelfingen (DE)

(21) Appl. No.: 19/240,510

(22) Filed: Jun. 17, 2025

(30) Foreign Application Priority Data
Jun. 20, 2024 (DE) 10 2024 117 393.9

(51) Int. Cl. F16K 7/14; F16K 25/00

(52) U.S. Cl. CPC F16K 7/14; F16K 25/005

(57) ABSTRACT

A multi-layer valve diaphragm for a diaphragm valve includes a first diaphragm layer configured to contact a process medium and a second diaphragm layer positioned on a dry side of the first layer. The second diaphragm layer includes a bracing section and a functional section that is at least partially surrounded by the bracing section. The bracing section and the functional section are arranged at least partially spaced apart from one another to reduce mechanical coupling between regions subject to static and dynamic stresses. This configuration improves the durability of the valve diaphragm during repeated actuation.

### TECHNICAL FIELD

This disclosure relates to a diaphragm valve, a valve diaphragm, and a diaphragm layer of a valve diaphragm.

### BACKGROUND

Process valves, including diaphragm valves, are widely used in fluid handling systems for controlling flow and isolating process media. These valves require reliable sealing between the valve diaphragm and the valve body to ensure leak-proof operation, particularly in applications involving corrosive, hazardous, or high-purity fluids.

During operation of a diaphragm valve with a valve diaphragm, static loads occur in one area of the valve diaphragm, and dynamic loads occur in another area of the valve diaphragm. The valve diaphragms are continuous across the areas. Due to the different load ranges, wear and failure of the valve diaphragm and therefore also of the diaphragm valve occur, for instance, in the transition area between these areas.

### SUMMARY

It is an object of present disclosure to reduce or eliminate the disadvantages known from the prior art to provide a valve diaphragm which is designed to be more durable.

A valve diaphragm includes a first diaphragm layer that contacts the media and a second diaphragm layer positioned on a dry side of the first diaphragm layer. The second diaphragm layer includes a bracing section and a functional section that are at least partially spaced apart to reduce wear due to dynamic and static load transitions. A separating section reduces load transfer and contact between the two regions, enhancing durability.

In some aspects of the present disclosure, a valve diaphragm comprises a first medium-contacting diaphragm layer and a second diaphragm layer arranged on a dry side of the first diaphragm layer. The second diaphragm layer comprises a bracing section and a functional section surrounding the bracing section, wherein in particular the bracing section and the functional section are stressed differently during operation of the diaphragm valve. The second diaphragm layer is formed separately from the first diaphragm layer.

In certain aspects of this disclosure, the bracing section and the functional section of the second diaphragm layer are arranged at least partially spaced apart from each other.

Such a spatial separation and/or decoupling of the bracing section and the functional section causes, for example, a static load on the bracing section to have no or less effect on the functional section and/or a dynamic load on the functional section to have no or less effect on the bracing section. Accordingly, the different loads can be distributed specifically to the different sections of the second diaphragm layer. In addition, friction between the bracing section and the functional section during the opening and closing movement of the functional section can be prevented or reduced.

The spaced-apart arrangement of the bracing section and the functional section can be realized in the second diaphragm layer by a separating section.

In some aspects of this disclosure, the separating section of the second diaphragm layer is designed as at least one recess which is at least partially annular, e.g., annular or semi-annular, and/or slot-like. The recess extends along a circle arranged around the actuating axis. The recess can extend over the entire height extension of the second diaphragm layer, wherein the height extension can run parallel to the actuating axis. In this case, the transition between the bracing section and the functional section is interrupted by the recess. Material of the bracing section and/or of the functional section can be displaced into the recess so that even in the event of elastic and/or plastic deformation, at least in the area of the recess, there is little or no contact between the bracing section and the functional section. This reduces friction and delays the onset of wear.

Alternatively, the separating section is configured as an at least partially annular perforation and/or surface structuring and/or material tapering, in particular a one- or two-sided groove with a groove bottom, and/or material weakening. This also leads to a weakening of the connection between the functional section and the bracing section. The separating section can be designed as a film hinge. In aspects, the separating section is configured as a predetermined breaking point during operation. Accordingly, the separating section connects the functional section and the bracing section in the assembled state and then tears or breaks upon the displacement of the functional section. In the operating state, the separating section is then formed by a crack or fracture running between the bracing section and the functional section along the predetermined breaking point.

In some aspects of this disclosure, the bracing section and the functional section of the first diaphragm layer are configured in one piece. Accordingly, the bracing section and the functional section of the first diaphragm layer are connected to each other. In this case, the transition between the bracing section and the functional section is continuous in form. This has the advantage that the first diaphragm layer seals the media-carrying through-line of the diaphragm valve, in particular in the direction of the second diaphragm layer and/or the drive.

In some aspects of this disclosure, the functional section has at least two flexing sections and/or at least one web-shaped sealing section. The sealing section separates the at least two flexing sections from each other. The sealing section is movable between an open position and a closed position. In the open position, the through-line is open. In the closed position, the scaling section of the second diaphragm layer presses the scaling section of the first diaphragm layer against a valve seat so that the sealing section of the first diaphragm layer rests against the valve seat. In this case, the through-line is advantageously closed. During the opening and closing movement, the flexing sections can each perform a flexing movement. Accordingly, the flexing sections and the sealing section are dynamically stressed by the opening and closing movement.

In some aspects of this disclosure, the first diaphragm layer also has a bracing section and a functional section with a sealing section and two flexing sections.

To simplify assembly, connecting sections for connecting the bracing section and the functional section can be provided between the bracing section and the functional section of the second diaphragm layer. During installation of the second diaphragm layer and/or the diaphragm valve, the relative position of the bracing section and of the functional section of the second diaphragm layer are therefore also fixed.

In some aspects of this disclosure, at least one first connecting section is provided connecting the bracing section and the functional section, in particular the sealing section. The first connecting section can be arranged in extension of the longitudinal extent of the sealing section. In some aspects of this disclosure, two first connecting sections are provided which are opposite one another along the longitudinal extent of the sealing section.

If the diaphragm layer has at least one connecting section, the recess is interrupted by the at least one connecting section and therefore has a semi-annular form.

In some aspects of this disclosure, at least one second connecting section is provided connecting the bracing section and the functional section, in particular the flexing section. The longitudinal extent of the second connecting section can enclose an angle with the longitudinal extent of the sealing section, which is greater than 0° and less than 180°, in particular between 60° and 120°, and in aspects, 90°. In some aspects of this disclosure, two, in particular opposite, second connecting sections are provided. A second connecting section connects one of the two flexing sections to the bracing section, and another second connecting section connects the other of the flexing sections to the bracing section.

The connecting sections, in particular the at least one first connecting section and/or the at least one second connecting section, can be configured as a predetermined breaking point. Accordingly, the connecting sections can be broken open after assembly and/or during operation, so that the connection between the bracing section and the functional section can be irreversibly broken. Accordingly, on the one hand, assembly is facilitated and, on the other hand, the decoupling of the bracing section and the functional section is realized. The predetermined breaking point can be achieved, for example, by a material tapering, perforation, providing a material with low breaking strength or other treatment weakening the breaking strength.

In some aspects of this disclosure, the bracing section and the functional section of the second diaphragm layer are connected to one another by the first diaphragm layer. In this example, the connection section shown can be omitted. The bracing section and the functional section of the second diaphragm layer are each glued to the first diaphragm layer, for example. Alternatively, it is conceivable for the first diaphragm layer and the second diaphragm layer to lie on top of each other unconnected.

An advantageous development provides that in the second diaphragm layer, a recess thickness is provided between a bracing inner surface of the bracing section extending at least substantially parallel to the actuating axis and a functional outer surface extending at least substantially parallel to the actuating axis. The recess thickness is greater than 5 mm, in particular greater than 7 mm, in aspects of this disclosure, greater than 10 mm, and/or less than 20 mm, in particular less than 17 mm, in some aspects of this disclosure, less than 15 mm. The recess thickness can be configured such that given normal deformation of the bracing section and/or of the functional section during operation, material can be displaced into the recess without contact occurring between the statically stressed bracing section and the dynamically stressed functional section.

The recess can be partially/semi-annular, and/or the functional outer surface can run in a circle.

Due to the decoupling of the bracing section and the functional section of the second diaphragm layer, the sections can easily be manufactured from different materials. Accordingly, the bracing section of the second diaphragm layer can be made of a first material, in particular a first ethylene propylene diene rubber (EPDM), and the functional section can be made of a second material different from the first material, in particular fluoroelastomer rubber (FKM), hydrogenated acrylonitrile butadiene rubber (HNBR) and/or a second EPDM. The flexing sections can be made of a third EPDM and/or the sealing section of FKM and/or HNBR. The first EPDM and/or the second EPDM and/or the third EPDM can be identical.

The valve diaphragm can comprise a third diaphragm layer. In some aspects of the present disclosure, the second diaphragm layer is arranged along the actuating axis between the first diaphragm layer and the third diaphragm layer. The third diaphragm layer can be configured as a back plate. The third diaphragm layer can have a bracing section and/or a functional section. Furthermore, the bracing section and the functional section can be arranged spaced apart from one another, corresponding to the second diaphragm layer, and furthermore can have an annular or partially annular recess.

In some aspects of this disclosure, the diaphragm valve comprises a media-carrying through-line and a previously described valve diaphragm for opening and closing the through-line.

One advantageous development provides that the functional section can be displaced along an actuating axis between an open position and a closed position. Accordingly, the functional section is dynamically stressed by the opening and closing movement. The first diaphragm layer and the second diaphragm layer and the third diaphragm layer can be arranged along the actuating axis.

An advantageous development provides that the diaphragm valve has a valve body and a drive housing arranged on the valve body, wherein the bracing section is braced, in particular statically, between the valve body and the drive housing. The bracing section can extend in a plane perpendicular to the actuating axis. In accordance with the present disclosure, the area of the diaphragm valve and/or the diaphragm layers is to be understood as a bracing section which is braced on the valve body and therefore does not move or does not move significantly despite an opening and closing movement of the valve diaphragm. Consequently, the bracing section is statically stressed.

One advantageous development provides that a driving force of a valve drive of the diaphragm valve can be introduced into the valve diaphragm via an actuating rod extending along the actuating axis and a pressure piece. The recess thickness can be less than or equal to the radial distance, with respect to the actuating axis, between an inner surface of the valve body and an outer surface of the pressure piece.

In aspects of the present disclosure, the first diaphragm layer is arranged between the through-line of the diaphragm valve and the second diaphragm layer.

In aspects of the present disclosure, the diaphragm layer has a bracing section and a functional section surrounding the bracing section, wherein the bracing section and the functional section are arranged at least partially spaced apart from one another, wherein at least one connecting section is provided connecting the bracing section and the functional section.

Further details and advantageous embodiments of the present disclosure can be found in the following description, by which exemplary embodiments of the present disclosure are further described and explained.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 is a schematic plan view of a first embodiment of a second diaphragm layer;

FIG. 2 is a schematic plan view of a second embodiment of a second diaphragm layer;

FIG. 3 is a schematic sectional view of a diaphragm valve with a second diaphragm layer according to FIG. 1;

FIGS. 4 to 6 are schematic detailed views of the separating section of the second diaphragm layer in different embodiments (material tapering, perforation, surface structuring); and

FIG. 7 is a schematic plan view of a third embodiment of a second diaphragm layer, wherein the separating section is formed according to FIG. 4b.

### DETAILED DESCRIPTION

As used herein, bracing section refers to a portion of a diaphragm layer that is fixed relative to the valve body and does not deform during valve actuation.

As used herein, functional section refers to a portion of a diaphragm layer that flexes during actuation to open or close the valve.

As used herein, separating section refers to a structural feature, such as a recess or material weakening, positioned between the bracing section and the functional section to reduce load transfer.

As used herein, dry side refers to the side of a diaphragm layer not in direct contact with process media.

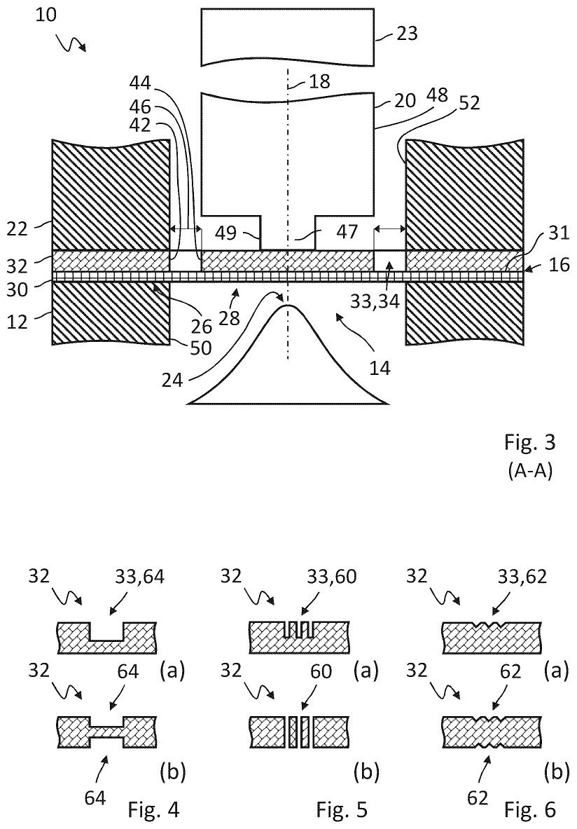

According to FIG. 3, the diaphragm valve 10 has a valve body 12 and a media-carrying through-line 14 surrounded by the valve body 12 and which can be opened and closed by means of a valve diaphragm 16. The valve diaphragm 16 is connected by means of a drive rod 20 extending along an actuating axis 18 to a drive 23 arranged in a bracing component 22 and indicated in FIG. 3. The bracing component 22 can be designed as the drive housing accommodating the drive and/or as an intermediate housing. If an intermediate housing is provided, it will preferably be arranged between the valve body and the actuator housing. By means of the drive rod 20, the valve diaphragm 16 can be moved between an upper opening position for opening the through-line 14 and a lower closing position. In the closed position, the pressure piece 47 presses the valve diaphragm 16 against a valve seat 24 shown in FIG. 3.

The valve diaphragm 16 has a bracing section 26 which is braced between the valve body 12 and the bracing component 22, in particular the drive housing and/or intermediate housing. Accordingly, the bracing section 26 is statically stressed during operation. The bracing section 26 preferably lies in a plane perpendicular to the actuating axis 18. In the bracing section 26, a plurality of through-holes are preferably provided for receiving fastening means (not shown) for fastening the drive housing 22 to the valve body 12. The valve diaphragm 16 further has a functional section 28 surrounded by the bracing section 26. The functional section 28 moves when the drive rod 20 is displaced. The functional section 28 is therefore dynamically stressed during operation of the diaphragm valve 10.

The valve diaphragm 16 includes a multilayer construction, and in the illustrated example of FIG. 3, comprises a first diaphragm layer 30 and a second diaphragm layer 32 arranged in stacked relationship. The first diaphragm layer 30 is positioned on the media-facing side of the valve diaphragm 16 and is primarily responsible for scaling the through-line 14. The second diaphragm layer 32 is positioned on the dry side of the valve diaphragm 16 and provides structural support and durability enhancements through separation of dynamic and static load regions.

During operation, the first diaphragm layer 30 is exposed to the media within the through-line 14 and therefore serves as the primary sealing surface. Preferably, this first diaphragm layer 30 is continuous and free of recesses or interruptions to maintain effective sealing along the fluid path. It also mechanically interfaces with the functional section of the second diaphragm layer 32 to translate actuation forces.

The second diaphragm layer 32 is located on the dry side 31 of the valve diaphragm 16, i.e., opposite the first diaphragm layer 30 relative to the media flow. This layer is shielded from direct media contact and can therefore be constructed using materials and geometries optimized for mechanical durability rather than chemical compatibility. The second diaphragm layer 32 includes a bracing section 26 and a functional section 28, which are spaced apart or decoupled by a separating section 33. The first diaphragm layer 30 lies between the media and the second diaphragm layer 32, providing a sealed interface while permitting the second diaphragm layer to absorb mechanical stresses.

Accordingly, the bracing section 26 and the functional section 28 of the second diaphragm layer 32 are arranged spaced apart from one another. The first diaphragm layer 30 is designed according to FIG. 3 continuous or in one-piece so that the bracing section 26 and the functional section 28 contact each other.

The decoupling of the bracing section 26 and the functional section 28 of the second diaphragm layer 32 has the advantage that the static load for fixing the valve diaphragm 16 is absorbed by the bracing section 26, and the dynamic load during the opening and closing movement of the valve diaphragm 16 is absorbed by the functional section 28. Furthermore, the friction of the bracing section 26 and the functional section 28 is reduced since due to the recesses 34 they do not contact each other and are only slightly connected to each other.

Alternatively, the separating section 33 according to FIGS. 4, 5 and 6 can also be designed as a material weakening, in particular perforation 60, surface structuring 62 or material tapering 64. In FIG. 4a, a groove with a groove bottom is provided on the upper side or the side of the second diaphragm layer facing away from the first diaphragm layer 30. In FIG. 4b, the groove with groove bottom is provided on both sides, in particular as a film hinge. In FIG. 5a, a needle-shaped perforation 60 is provided in the upper side, or the side of the second diaphragm layer 32 facing away from the first diaphragm layer 30, and does not extend through the entire second diaphragm layer 32. In FIG. 4b, the needle-shaped perforation 60 is continuous, e.g., over the entire height extension of the second diaphragm layer 32. In FIG. 6a, a regular and/or irregular surface structuring 62 is provided on the upper side or the side of the second diaphragm layer 32 facing away from the first diaphragm layer 30. In FIG. 6b, the surface structuring 62 is provided on both sides. A combination of the shown material weakenings is also conceivable in the separating section, e.g., material tapering and/or surface structuring and/or perforation. In this case, material is provided between the bracing section 26 and the functional section 28. However, it is configured in such a way that the coupling of the bracing section 26 and the functional section 28 is reduced. Furthermore, the functional section 28 can be configured as a predetermined breaking point so that it tears or breaks during operation of the diaphragm valve 10, due to the movement of the functional section 28 along the actuating axis 18. Accordingly, a similar or identical effect can be achieved as with the recess 34.

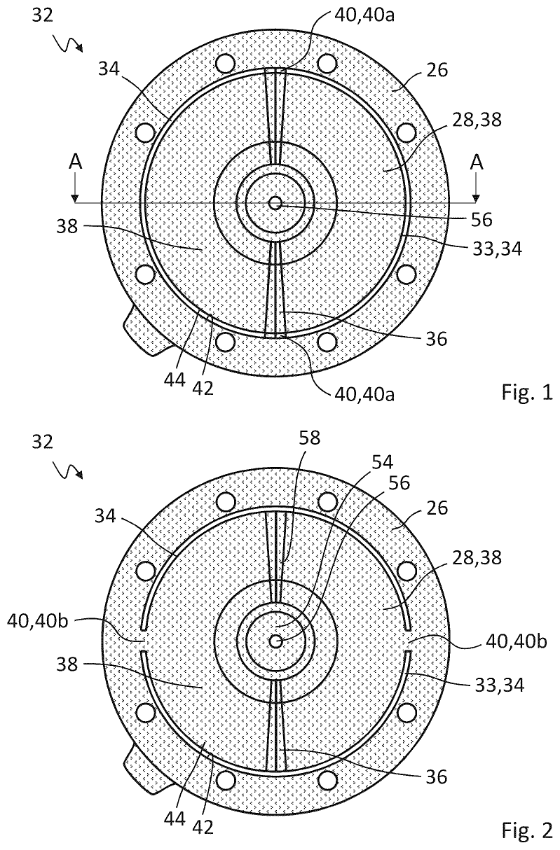

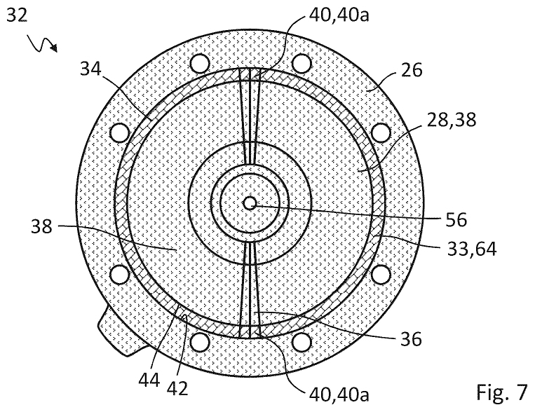

In FIG. 7, a second diaphragm layer 32 with a separating section 33 according to FIG. 4b is shown, wherein the separating section 33 is formed along the entire circumference of the second diaphragm layer 32 as a material tapering 64 on both sides. Accordingly, the second diaphragm layer 32 has a circumferential film hinge. Alternatively, the separating section 33 in FIG. 7 is designed according to any of the further embodiments in FIGS. 4a-6b. The special configuration of the separating section 33 according to FIGS. 4a-6b can be formed over the entire circumference or in sections. Accordingly, in the non-specially formed areas, there can be a recess according to FIG. 1 or solid material as in the other areas 26, 28 of the second material layer.

The functional section 28 has a web-shaped sealing section 36 and two flexing sections 38, wherein the sealing section 36 separates the flexing sections 38 from one another. The sealing section 36 of the second diaphragm layer 32 pushes the sealing section 36 of the first diaphragm layer 30 in the direction of the valve seat 24 so that the sealing section 36 of the first diaphragm layer comes into contact with the valve seat (not shown) in the closed position.

The sealing section 36 can have a first web section 54 as well as two second web sections 58 facing the bracing section 26. The sealing section 36 can have a through-hole 56, in the area of the first web section 54. A pin of the diaphragm shield is passed through the through-hole 56 and hooked into the drive rod 20. The pin is preferably incorporated into the valve diaphragm 16 and is used to pull it off the valve seat 24.

According to FIGS. 1 and 2, the second diaphragm layer 32 has connecting sections 40 which connect the bracing section 26 and the functional section 28 to one another like a web. The connecting sections 40 interrupt the annular recess 34 so that several semi-annular recesses 34 are provided. Alternatively, it is conceivable for only an annular recess 34 without connecting sections 40 to be provided.

As an alternative to the embodiment shown, the recess 34 is not continuous but rather groove-shaped. Another example of the recess 34 comprises an annular perforation or predetermined breaking point. If the bracing section 26 and the functional section 28 are connected by the separating section, a connecting section 40 can be dispensed with.

Two arrangements of the connecting sections 40 are shown in FIGS. 1 and 2. In FIG. 1, two opposing first connecting sections 40a are provided which are arranged in extension of the longitudinal extent of the sealing section 36. Accordingly, the first connecting sections 40a connect the bracing section 26 and the sealing section 36 of the second diaphragm layer 32 on both sides.

In FIG. 2, two opposing second connecting sections 40b are provided, wherein the longitudinal extent of the second connecting sections 40b encloses an angle greater than 0° and less than 180°, between 60° and 120°, and in certain aspects of this disclosure, 90°, with the longitudinal extent of the sealing section. Accordingly, the left-hand second connecting section 40b connects the left-hand flexing section 38 to the bracing section 26 of the second diaphragm layer 32, and the right-hand second connecting section 40b connects the right-hand flexing section 38 to the bracing section 40b of the second diaphragm layer 32.

Alternatively, it is conceivable for a plurality of, e.g., two, first connecting sections 40a and a plurality of, e.g., two, second connecting sections 40b to be provided in the second diaphragm layer 32. The connecting sections 40 can be arranged in pairs opposite one another.

The connecting sections 40 can be configured as predetermined breaking points. Accordingly, after assembly and/or during operation, the connecting sections 40 can be broken open so that the connection between the bracing section 26 and the functional section 28 can be irreversibly broken. Accordingly, on the one hand, assembly is facilitated and, on the other hand, the decoupling of the bracing section 26 and the functional section 28 is realized. The predetermined breaking point can be achieved, for example, by a material tapering, perforation, providing a material with low breaking strength or other treatment weakening the breaking strength. This also applies to the separating section.

Due to the spaced-apart arrangement of the bracing section 26 and the functional section 28, a bracing inner surface 42 of the bracing section 26 and a functional outer surface 44 of the functional section 28 are formed at the free radial ends. The distance between the bracing inner surface 42 and the functional outer surface 44 forms the recess thickness 46 of the recess 34 which is measured perpendicular to the actuating axis 18. The recess thickness 46 is greater than 5 mm, greater than 7 mm, in some aspects of this disclosure, greater than 10 mm, and/or less than 20 mm, less than 17 mm, and in some aspects of this disclosure, less than 15 mm. The recess thickness 46 can be configured such that, given normal deformation of the bracing section 26 and/or the functional section 28 during operation, material can be displaced into the recess 34 without contact occurring between the statically stressed bracing section 26 and the dynamically stressed functional section 28.

Furthermore, the drive rod 20 has a drive rod outer surface 48 along its circumference running parallel to the actuating axis 18. In addition, the valve body 12 has a valve body inner surface 50 running parallel to the actuating axis 18, and/or the drive housing 22 has a drive housing inner surface 52 running parallel to the actuating axis 18. The recess thickness 46 can be less than or equal to the radial distance, with respect to the actuating axis 18, between a pressure piece outer surface 49 of the pressure piece 47 and the valve body inner surface 50, and/or between the drive rod outer surface 48 and the actuator housing inner surface 52. Alternatively, the recess thickness 46 is less than or equal to the radial distance, with respect to the actuating axis 18, between the drive rod outer surface 48 and the valve body inner surface 50, and/or between the drive rod outer surface 48 and the actuator housing inner surface 52.

The second diaphragm layer 32 can be made of a first EPDM in the bracing section 26, of FKM in the sealing section 36 and of a second EPDM in the flexing sections 38.

### LIST OF REFERENCE NUMBERS

10 Diaphragm valve
12 Valve body
14 Through-line
16 Valve diaphragm
18 Actuating axis
20 Drive rod
22 Drive housing
23 Drive
24 Valve seat
26 Bracing section
28 Functional section
30 First diaphragm layer
31 Dry side of the first diaphragm layer
32 Second diaphragm layer
33 Separating section
34 Recesses
36 Sealing section
38 Bracing sections
40 Connecting sections
40a First connecting sections
40b Second connecting sections
42 Bracing inner surface
44 Functional outer surface
46 Recess thickness
47 Pressure piece
48 Drive rod outer surface
49 Pressure piece outer surface
50 Valve body inner surface
52 Drive housing inner surface
54 First web section
56 Through-hole
58 Second web section
60 Perforation
62 Surface structuring
64 Material tapering

Advantageously, the valve diaphragm described herein provides improved operational durability by structurally decoupling regions subjected to static and dynamic loads. This configuration reduces friction and material fatigue at the transition zone between the bracing and functional sections, which is a common failure point in conventional diaphragms. The inclusion of a separating section, which may be formed as a recess, material weakening, or predetermined breaking point, further enhances mechanical isolation and allows for tailored material use in each section. This multi-layer design permits high-performance sealing using media-compatible materials while also enabling mechanical reinforcement using materials optimized for structural support. As a result, the valve diaphragm is capable of extended service life during repetitive actuation, reduced maintenance intervals, and improved reliability in demanding fluid control environments.

To the extent not already described, the different features and structures of the various embodiments can be used in combination, or in substitution with each other as desired. That one feature is not illustrated in all the embodiments is not meant to be construed that it cannot be so illustrated, but is done for brevity of description. Thus, the various features of the different embodiments can be mixed and matched as desired to form new embodiments, whether the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure. Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A multi-layer valve diaphragm for a diaphragm valve, comprising:
a first diaphragm layer configured to contact media; and
a second diaphragm layer disposed on a dry side of the first diaphragm layer, the second diaphragm layer includes a bracing section and a functional section at least partially spaced apart from each other, wherein the bracing section surrounds the functional section.

2. The valve diaphragm of claim 1, wherein the second diaphragm layer includes at least one separating section disposed between the bracing section and the functional section.

3. The valve diaphragm of claim 2, wherein the separating section comprises a recess or a material weakening feature selected from the group consisting of a perforation, surface structuring, and material tapering.

4. The valve diaphragm of claim 1, wherein the first diaphragm layer includes a bracing section and a functional section formed integrally with one another.

5. The valve diaphragm of claim 1, wherein the functional section includes at least two flexing sections and a web-shaped sealing section disposed between the flexing sections.

6. The valve diaphragm of claim 1, further comprising at least one first connecting section extending between the bracing section and the functional section, wherein the first connecting section is aligned with a longitudinal extent of the sealing section.

7. The valve diaphragm of claim 1, further comprising at least one second connecting section extending between the bracing section and the functional section, wherein the second connecting section is oriented at an angle greater than 0 degrees and less than 180 degrees relative to a longitudinal extent of the sealing section.

8. The valve diaphragm of claim 5, wherein the at least one first connecting section or the at least one second connecting section is configured as a predetermined breaking point.

9. The valve diaphragm of claim 1, wherein the bracing section and the functional section of the second diaphragm layer are connected by the first diaphragm layer.

10. The valve diaphragm of claim 1, wherein the second diaphragm layer defines a recess thickness between an inner surface of the bracing section and an outer surface of the functional section, the recess thickness being greater than 5 mm and less than 20 mm.

11. The valve diaphragm of claim 1, wherein the bracing section of the second diaphragm layer is formed from a first material and the functional section is formed from a second material different from the first material.

12. The valve diaphragm of claim 1, further comprising a third diaphragm layer arranged on a side of the second diaphragm layer opposite the first diaphragm layer, the third diaphragm layer including a bracing section and a functional section arranged at least partially spaced apart from one another.

13. A diaphragm valve comprising:
a media-carrying flow path; and
a valve diaphragm according to claim 1, configured to open and close the flow path.

14. The diaphragm valve of claim 13, wherein the functional section of the valve diaphragm is configured to move along an actuating axis between an open position and a closed position.

15. The diaphragm valve of claim 13, further comprising a valve body and a drive housing secured to the valve body, wherein the bracing section of the valve diaphragm is statically retained between the valve body and the drive housing.

16. The diaphragm valve of claim 13, further comprising a drive rod and a pressure piece for actuating the valve diaphragm, and wherein the recess thickness between the bracing section and the functional section is less than or equal to a radial distance between a surface of the valve body and a surface of the pressure piece, measured with respect to the actuating axis.

17. A diaphragm layer for a multi-layer valve diaphragm, comprising:
a bracing section;
a functional section at least partially surrounded by the bracing section and spaced apart therefrom; and
at least one connecting section connecting the bracing section and the functional section in a pre-assembly state, wherein the connecting section is configured to separate during operation.

18. A method for assembling or operating a diaphragm valve, comprising:
inserting a diaphragm layer into the valve in a pre-assembled state in which the diaphragm layer includes a bracing section and a functional section connected by at least one connecting section; and
separating the connecting section during operation so that the diaphragm layer comprises distinct bracing and functional sections in an operational state.

19. The method of claim 18, wherein the separating step includes actuating the functional section of the diaphragm layer for the first time to move between an open position and a closed position.
